(19) United States
(12) Patent Application Publication
(10) Pub. No.: US 2016/0041703 A1
(43) Pub. Date: Feb. 11, 2016

(54) CHARACTER STRING SELECTING APPARATUS, CHARACTER STRING SELECTING METHOD, AND COMPUTER-READABLE MEDIUM STORING CHARACTER STRING SELECTING PROGRAM

(71) Applicants: Tatsuo Kakuta, Chiba (JP); Masahiro Nishibori, Tokyo (JP); Kouji Sato, Tokyo (JP)

(72) Inventor: Masahiro Nishibori, Tokyo (JP)

(73) Assignee: Tatsuo Kakuta et al.

(21) Appl. No.: 14/816,970

(22) Filed: Aug. 3, 2015

(30) Foreign Application Priority Data
Aug. 6, 2014 (JP) 2014-160539

(51) Int. Cl. G06F 3/0482; G06F 3/0485; G06F 3/0484

(52) U.S. Cl. CPC G06F 3/0482; G06F 3/04842; G06F 3/0485

(57) ABSTRACT

A character string selecting apparatus is provided with a menu display unit for setting a plurality of menu display areas, displaying, in a first column of the menu display area, selection target character strings extracted at intervals from selection target character strings provided with a display order, and displaying, in an i-th column, selection target character strings extracted at intervals smaller than intervals of extraction in an i-1-th column; a slide operation processing unit for scrolling display of selection target character strings of a j-th column in response to slide operation in the j-th column and display of the selection target character strings of the other columns in conjunction with each other based on amounts of scrolling according to the intervals of extraction; and a character string selection unit for specifying a selection target character string selected in one of the columns as an input character string.

### CROSS-REFERENCE TO RELATED APPLICATION

This application for the present invention is based upon and claims the benefit of priority of the prior Japanese Patent Application No. 2014-160539, filed on Aug. 6, 2014, the entire contents which are incorporated herein by reference.

### BACKGROUND OF THE INVENTION

1. Field of the Invention

The present invention relates to a character string selecting apparatus, a character string selecting method and a computer-readable medium storing a character string selecting program for a user to select a displayed character or character string to input the character or the character string.

2. Description of the Related Art

Examples of conventional character or character string input systems include input methods, such as keyboard input, handwriting input, and voice input. In recent years, an input system is also known, wherein characters or character strings as input targets are displayed to input a displayed character or character string by selecting the character or the character string. For example, in Japanese Laid-Open Patent No. 9-222944, a dictionary for input is configured to set characters or character strings arranged in a predetermined order and grouped into a plurality of hierarchic classes, where a top item of each group is set as an item of an upper class; menus of lower classes including a top item that is an item designated in a menu displaying characters or character strings of the dictionary for input are sequentially displayed; and a character or a character string selected in the displayed hierarchical menus is set as an input character or an input character string.

### SUMMARY OF THE INVENTION

In Japanese Laid-Open Patent No. 9-222944, a user needs to repeat operation of designating a character or a character string to be displayed in a lower class from the displayed characters or character strings of the dictionary for input until a desired character string is displayed. When a large number of characters or character strings are registered in the dictionary for input, the number of times of operation for designating a class displaying a desired character or character string increases with an increase in the number of classes. Therefore, there is a problem that the operations to the operation of selecting the character or the character string as an input target are cumbersome.

An aspect of the present invention is provides an apparatus for easily selecting a character string with as few operations as possible when a user is about to select one among displayed character strings as an input target.

To solve the problem, a character string selecting apparatus disclosed as an aspect of the present invention is an apparatus for a user to select a character string from a plurality of selection target character strings displayed on a display apparatus, the apparatus includes a storage unit for storing the plurality of selection target character strings provided with an order relation of a display order; a menu display unit; a slide operation processing unit; and a character string selection unit.

The menu display unit is a processing unit for setting n (n is an integer equal to or greater than 2) number of menu display areas on a display screen of the display apparatus; displaying, in a first menu display area, selection target character strings extracted at intervals in the display order from among the plurality of selection target character strings stored in the storage unit; and displaying, in an i-th (2≦i≦n) menu display area, selection target character strings extracted at intervals smaller than intervals of selection target character strings displayed in an i-1-th menu display area.

The slide operation processing unit is a processing unit for receiving input of slide operation in the n number of menu display areas; scrolling and displaying selection target character strings in a j-th (1≦j≦n) menu display area in response to the input of the slide operation in the j-th menu display area; and scrolling and displaying the selection target character strings in the other menu display areas in conjunction with each other based on amounts of scroll according to the intervals.

The character string selection unit is a processing unit for receiving input of selection operation of a selection target character string in the n number of menu display areas to specify the selected selection target character string.

An example of process of the present invention is as follows. When a process is started in the present invention, the menu display unit sets the n number of menu display areas on the display screen of the display apparatus and displays, in the first menu display area, the selection target character strings extracted at the intervals in the display order from among the plurality of selection target character strings stored in the storage unit. The menu display unit further displays, in the i-th menu display area, the selection target character strings extracted at the intervals smaller than the intervals of the selection target character strings displayed in the i-1-th menu display area.

The slide operation processing unit receives input of slide operation by the user in one of the n menu display areas displayed on the display screen, scrolls and displays the selection target character strings in the j-th menu display area according to the input of the slide operation in the j-th menu display area with the input, and scrolls and displays the selection target character strings in the other menu display areas in conjunction with each other based on the amounts of scroll according to the intervals in the menu display areas.

Subsequently, when the user inputs selection operation of a selection target character string in the n number of menu display areas displayed on the display screen, the character string selection unit receives the input of the selection operation and specifies the selected selection target character string.

Further, in the character string selecting apparatus, the intervals may be certain intervals that are preset for each of the menu display areas or intervals that are set based on additional information (for example, degree of importance) provided in advance to each of the selection target character strings.

Another aspect of the present invention provides a method for easily selecting a character string with as few operations as possible when a user is about to select one among displayed character strings as an input target. Yet another aspect of the present invention provides a computer-readable medium storing a character string selecting program which causes a computer to execute the process executed by each units included in the character string selecting apparatus.

According to the present invention, the selection target character strings extracted at different intervals in each of the menu display areas from the plurality of selection target character strings stored in the storage unit are displayed in the plurality of menu display areas. The plurality of selection character strings provided with the display order are simultaneously displayed as lines of the selection character strings indicated in ranges with different sizes. The selection target character strings of the plurality of menu display areas are scrolled and displayed in conjunction with each other according to one slide operation by the user. This can provide character string selection input unit that allows easily selecting a character string with a small number of operations from a plurality of selection target character strings, particularly, a large number of selection target character strings.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating a configuration example of a character string selecting apparatus according to a first embodiment of the present invention;

FIG. 2 is a diagram illustrating an example of menu display areas of a display screen of a display and input apparatus according to the first embodiment of the present invention;

FIG. 3 is a diagram illustrating an example of a plurality of selection target character strings stored in a storage unit according to the first embodiment of the present invention;

FIGS. 4A-4C are diagrams for describing scroll display of the selection target character strings of the menu display areas displayed on the display screen of the display and input apparatus according to the first embodiment of the present invention;

FIG. 5 is a diagram illustrating a processing flow example of a menu display unit of the character string selecting apparatus according to the first embodiment of the present invention;

FIG. 6 is a diagram illustrating an example of the menu display areas displayed on the display screen of the display and input apparatus through the processing flow shown in FIG. 5;

FIG. 7 is a diagram illustrating a processing flow example of a slide operation processing unit and a character string selection unit of the character string selecting apparatus according to the first embodiment of the present invention;

FIG. 8 is a diagram illustrating an example of the menu display areas at the time of input of slide operation according to the first embodiment of the present invention;

FIG. 9 is a diagram illustrating an example of scroll display of the menu display areas corresponding to the slide operation according to the first embodiment of the present invention;

FIG. 10 is a diagram illustrating an example of a plurality of selection target character strings stored in the storage unit according to a second embodiment of the present invention;

FIG. 11 is a diagram illustrating a processing flow example of the menu display unit of the character string selecting apparatus according to the second embodiment of the present invention;

FIG. 12 is a diagram illustrating a display example of the menu display areas displayed on the display screen of the display and input apparatus through the processing flow shown in FIG. 11;

FIG. 13 is a diagram illustrating a processing flow example of the slide operation processing unit and the character string selection unit of the character string selecting apparatus according to the second embodiment of the present invention;

FIG. 14 is a diagram illustrating an example of scroll display of the menu display areas corresponding to slide operation according to the second embodiment of the present invention;

FIG. 15 is a diagram illustrating an example of the menu display areas displayed on the display screen of the display and input apparatus according to a third embodiment of the present invention; and

FIG. 16 is a diagram illustrating a hardware configuration example of the character string selecting apparatus of the present invention.

### DETAILED DESCRIPTION OF THE PREFERRED EMBODIMENTS

A character string selecting apparatus disclosed as an aspect of the present invention will now be described.

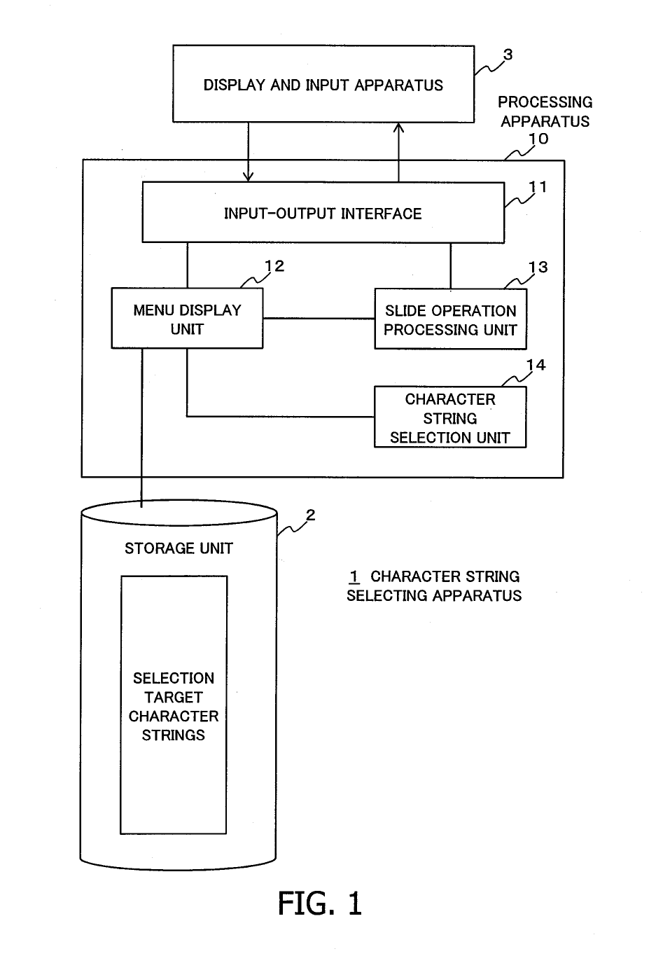

FIG. 1 is a diagram illustrating a configuration example of the character string selecting apparatus according to an embodiment (first embodiment). FIG. 1 depicts a character string selecting apparatus 1, a storage unit 2, a display and input apparatus 3, a processing apparatus 10, an input-output interface 11, a menu display unit 12, a slide operation processing unit 13, and a character string selection unit 14.

The processing apparatus 10 of the character string selecting apparatus 1 is a processing apparatus including a CPU, a memory and the like, and includes the input-output interface 11, the menu display unit 12, the slide operation processing unit 13, and the character string selection unit 14.

The storage unit 2 stores a plurality of selection target character strings provided with an order relation of a display order.

The display and input apparatus 3 displays, on a display screen, a plurality of menu display areas displaying the plurality of selection target character strings stored in the storage unit 2 and inputs slide operation or selection operation by a user. The display and input apparatus 3 can be implemented by, for example, a touch screen display.

The input-output interface 11 is a processing unit that transmits and receives input-output signals between the processing apparatus 10 and the display and input apparatus 3.

The menu display unit 12 sets n (n is an integer equal to or greater than 2) number of menu display areas on the display screen of the display and input apparatus 3, displays, in a first menu display area, selection target character strings extracted at intervals in the display order from among the plurality of selection target character strings stored in the storage unit 2, and displays, in an i-th (2≦i≦n) menu display area, selection target character strings extracted at intervals smaller than intervals of selection target character strings displayed in an i-1-th menu display area.

The slide operation processing unit 13 receives input of slide operation in the n menu display areas from the display and input apparatus 3, scrolls and displays selection target character strings in a j-th (1≦j≦n) menu display area displayed on the display screen of the display and input apparatus 3 in response to input of slide operation in the j-th menu display area, and scrolls and displays selection target character strings in the other menu display areas in conjunction with each other based on amounts of scroll according to the intervals.

The character string selection unit 14 receives input of selection operation of a selection target character string in the n number of menu display areas displayed on the display screen of the display and input apparatus 3 and specifies the selected selection target character string.

Process of the character string selecting apparatus 1 will now be described. For the convenience of the description, for example, the n number is set three (n=3). That is, the character string selecting apparatus 1 sets three menu display areas on the display screen of the display and input apparatus 3, will be described.

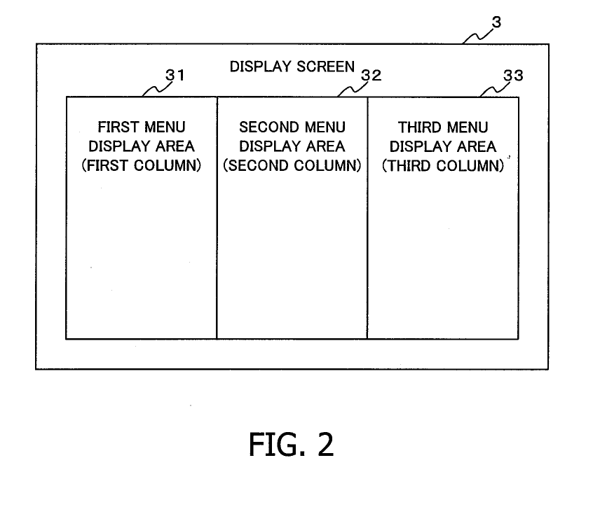

FIG. 2 is a diagram illustrating an example of the menu display areas of the display screen of the display and input apparatus 3. The menu display unit 12 sets three menu display areas on the display screen of the display and input apparatus 3. The menu display areas include, from left to right, a first menu display area (first column) 31, a second menu display area (second column) 32, and a third menu display area (third column) 33.

To facilitate understanding of the first embodiment, an image of menu display and an input method according to the first embodiment will be briefly described. All selection target character strings are display targets in the third menu display area 33. Some selection target character strings of the display targets in the third menu display area 33 are display targets in the second menu display area 32. Some selection target character strings of the display targets in the second menu display area 32 are display targets in the first menu display area 31.

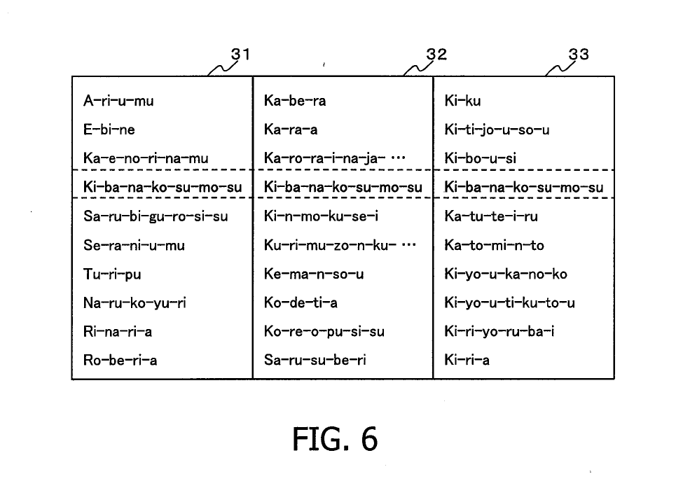

The selection target character strings are displayed in the menu display areas 31 to 33 as described later in FIG. 6. The selection target character strings can be viewed as if the character strings are written on rotatable cylindrical peripheral surfaces as in a slot machine. When a user operates a finger swipe on any one of the menu display areas 31 to 33, the selection target character strings displayed in the menu display area are changed as if the cylinder rotates. Here, the other menu display areas also rotate in conjunction when any one of the menu display areas is touched by a finger swipe operation. The rotation speed of the third menu display area 33 is the largest, and the rotation speed of the first menu display area is the smallest.

For basic operation by the user to input a character string to be selected, the user operates the menu display areas 31 to 33 by a finger swipe to display a selection target character string to be selected and then presses (or operates a finger tap) the selection target character string to be selected when the character string is displayed in one of the menu display areas 31 to 33.

Here, swiping by a finger or a finger swipe may is called slide operation, and pressing by a finger is be called tap operation. The slide operation and the tap operation, however, may not be operation using a finger, and for example, the slide operation and the tap operation may be operation with similar action, such as dragging and clicking by a mouse or other input apparatuses. Although the menu display areas are displayed in a cylindrical form in the description to facilitate understanding of the description, the menu display areas are not actually displayed in a cylindrical shape.

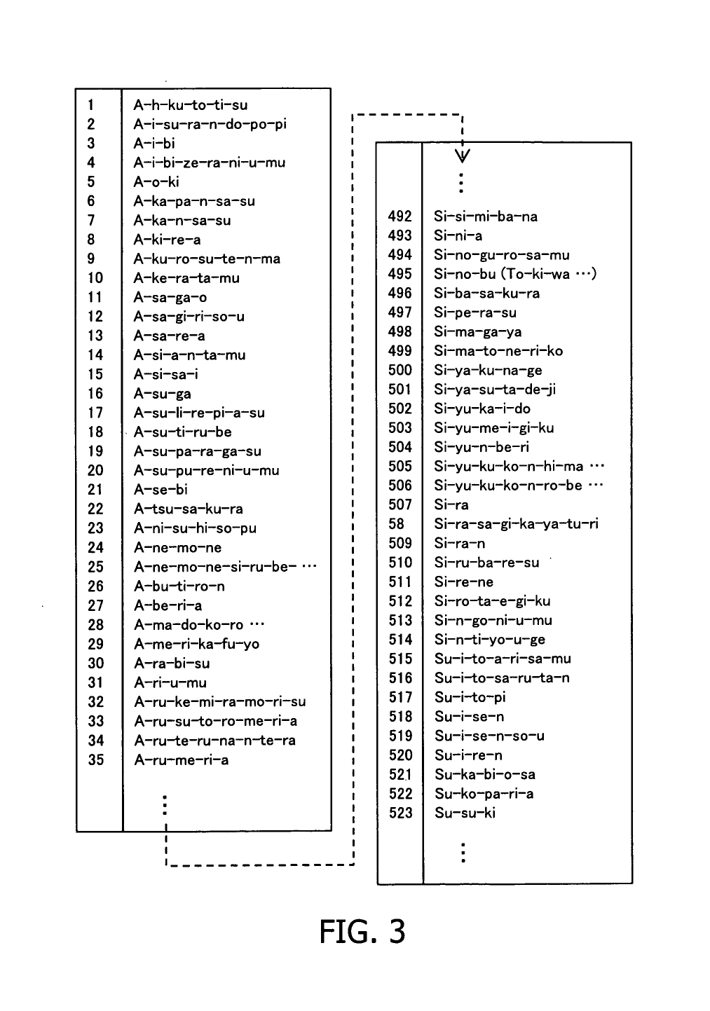

FIG. 3 is a diagram illustrating an example of the plurality of selection target character strings stored in the storage unit 2. Numbers on the left side of the plurality of selection target character strings shown in FIG. 3 indicate the display order. The plurality of selection target character strings of the storage unit 2 are an arrangement of plant names in which the order relation of the display order is set in the order of Japanese kana “a, i, u, e, o”. Other than the arrangement of the plant names as shown in FIG. 3, the plurality of selection target character strings may be an arrangement of character strings indicating music names, artist names, facility names for navigation, or the like.

For each of the menu display areas (the first to the third columns) set on the display screen, the menu display unit 12 extracts a plurality of selection target character strings stored in the storage unit 2 at intervals for extracting the selection target character strings from the storage unit 2 and displays the character strings in each column.

Predetermined values are set in advance as the intervals for extracting the selection target character strings. Different values are set for an interval s1 for extracting the selection target character strings displayed in the first column 31, an interval s2 for extracting the selection target character strings displayed in the second column 32, and an interval s3 for extracting the selection target character strings displayed in the third column 33. The values are set so that the value of the intervals s1 is the largest (widest intervals), and the values become smaller (narrower) in the order of the intervals s2 and s3. The value of interval sn of an n-th column (third column here) is the smallest (narrowest intervals).

For example, “100” is set for the interval s1 of the first column 31, “10” is set for the interval s2 of the second column 32, and “1” is set for the interval s3 of the third column 33. The interval s1 “100” denote that 99 selection target character strings are skipped in a predetermined order, and every 100th selection target character string is extracted. The interval s2 “10” denote that nine selection target character strings are skipped, and every tenth selection target character string is extracted. The interval s3 “1” denote that a plurality of selection target character strings are sequentially extracted one by one without skipping.

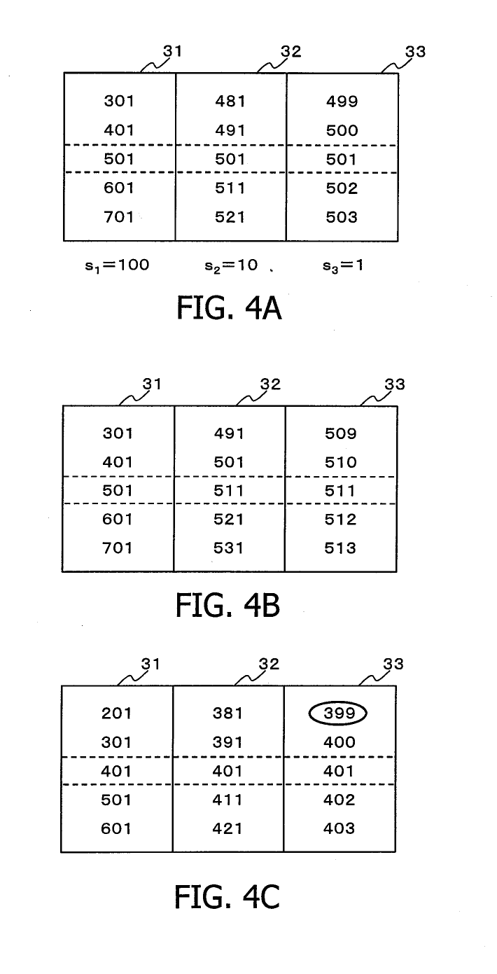

FIGS. 4A-4C are diagrams for describing scrolling of display of the selection target character strings displayed in the menu display areas.

FIG. 4A illustrates an example of the menu display areas in initial display of the display screen of the display and input apparatus 3. Each menu display area (column) shown in FIG. 4A includes five display rows, and a third row is a reference row. Although the reference row can be any row at a position easy for the user to view, it is preferable that the row positions are the same in a plurality of columns.

The menu display unit 12 first extracts selection target character strings with numbers 1, 101, 201, 301, 401, . . . at the intervals s1 (every 100th character string) from the plurality of selection target character strings stored in the storage unit 2. The menu display unit 12 further displays, in the first column 31, the selection target character strings with numbers 301, 401, 501, 601, and 701 among the extracted selection target character strings so that the selection target character string with a predetermined number or extracted order is positioned in the reference row of the first column 31.

The menu display unit 12 further extracts the selection target character strings with numbers 1, 11, 21, 31, 41, . . . at the intervals s2 (every tenth character string) from the plurality of selection target character strings of the storage unit 2. The menu display unit 12 then displays, in the second column 32, previous and subsequent selection target character strings with numbers 481, 491, 501, 511, and 521 based on the selection target character string corresponding to the selection target character string in the reference row of the first column 31 among the extracted selection target character strings.

Furthermore, the menu display unit 12 sequentially extracts the selection target character strings at the intervals s3 (1), i.e. one by one, and displays, in the third column 33, previous and subsequent selection target character strings with numbers 499, 500, 501, 502, and 503 based on the selection target character string in the reference row of the second column 32.

FIG. 4B illustrates an example (1) of the scroll display based on input of slide operation.

When a slide operation in a menu display area of the display screen is input in the display and input apparatus 3 that displays the menu display areas of FIG. 4A, the slide operation processing unit 13 receives the input of the slide operation through the input-output interface 11 and scrolls display of the selection target character strings in the menu display area with the input of the slide operation according to a slide direction and an amount of slide of the received slide operation. The slide operation processing unit 13 further scrolls the display of the selection target character strings of the rest of the menu display areas, in which the input of the slide operation is not detected, in conjunction with the scrolling the display of the menu display area with the input of the slide operation.

Specifically, for each column that does not have the input of the slide operation in the first to third columns 31 to 33 of the display screen, the slide operation processing unit 13 calculates an amount of scrolling using the amount of slide of the slide operation and a ratio of the intervals s (s1, s2, and s3) of the column that has the input of the slide operation and the column that does not have the input to calculate the amount of scroll then scrolls the display of the selection target character strings based on the calculated amount of scroll.

When the slide operation processing unit 13 receives input of slide operation for one row in the upper direction in the second column 32 in the menu display areas of FIG. 4A, the slide operation processing unit 13 scrolls the selection target character strings of the second column 32 according to the slide operation (one row in the upper direction) and displays a line of the selection target character strings with numbers 491, 501, 511, 521, and 531 as shown in FIG. 4B.

Assuming that the interval s1, s2, and s3 corresponding to the first to third columns 31 to 33 are “100”, “10”, and “1”, respectively, the slide operation processing unit 13 scrolls the displays of the selection target character strings of each column as follows. While scrolling and displaying the second column 32 based on the amount of slide, the slide operation processing unit 13 calculates the amount of scroll of the third column 33 based on the amount of slide (one row) and the ratio (s2/s3) of the interval s2 corresponding to the second column 32 and the interval s3 corresponding to the column (third column). The slide operation processing unit 13 scrolls the selection target character strings in the upper direction based on the obtained amount of scroll (ten rows) and displays the selection target character strings with numbers 509, 510, 511, 512, and 513.

Similarly, the slide operation processing unit 13 calculates the amount of scroll of the first column 31 based on the amount of slide (one row) and the ratio (s2/s1) of the interval s2 corresponding to the second column 32 and the interval s1 corresponding to the column (first column). Since the obtained amount of scroll (1/10 rows) is sufficiently smaller than the row width, the slide operation processing unit 13 displays the line of the selection target character strings with numbers 301, 401, 501, 601, and 701 as it is. The line of the selection target character strings of the first column 31 may be displayed by shifting the line in the upper direction based on the obtained amount of scroll (1/10 rows).

FIG. 4C illustrates an example (2) of the scroll display based on input of slide operation.

When a slide operation is input in the first column 31 in the display and input apparatus that displays the menu display areas of FIG. 4A, the slide operation processing unit 13 receives the input of the slide operation. The slide operation processing unit 13 scrolls the selection target character strings of the first column 31 according to the slide operation (one row in the lower direction) and displays the selection target character strings with numbers 201, 301, 401, 501, and 601 as shown in FIG. 4C. As in the process described with reference to FIG. 4B, the slide operation processing unit 13 further calculates the amounts of scroll of the second column 32 and the third column 33 during the scroll display of the first column 31 and scrolls and displays the second column 32 and the third column 33.

For the second column 32, the slide operation processing unit 13 scrolls the selection target character strings in the same direction based on the calculated amount of scroll (ten rows) and displays the selection target character strings with numbers 381, 391, 401, 411, and 421. For the third column 33, the slide operation processing unit 13 scrolls the selection target character strings in the same direction based on the calculated amount of scroll (100 rows) and displays the selection target character strings with numbers 399, 400, 401, 402, and 403.

As described, in conjunction with the scroll display based on the slide operation in one menu display area of the display screen, the selection target character strings are also scrolled and displayed in the other menu display areas. However, the amounts of scroll are different according to the ratios of the intervals corresponding to the menu display areas, and the selection target character strings of the menu display areas on the display screen of the display and input apparatus 3 are scrolled and displayed at different speeds.

Subsequently, when a selection operation for a selection target character string is input in the third column 33 of the display screen of the display and input apparatus 3 shown in FIG. 4C, the character string selection unit 14 receives the input of the selection operation through the input-output interface 11 and specifies the selection target character string with number 399 selected in the selection operation. The selection target character string with number 399 specified by the character string selection unit 14 is transmitted as a processing result to an input request source, such as another application program or another processing apparatus.

A processing flow of the character string selecting apparatus 1 will now be described.

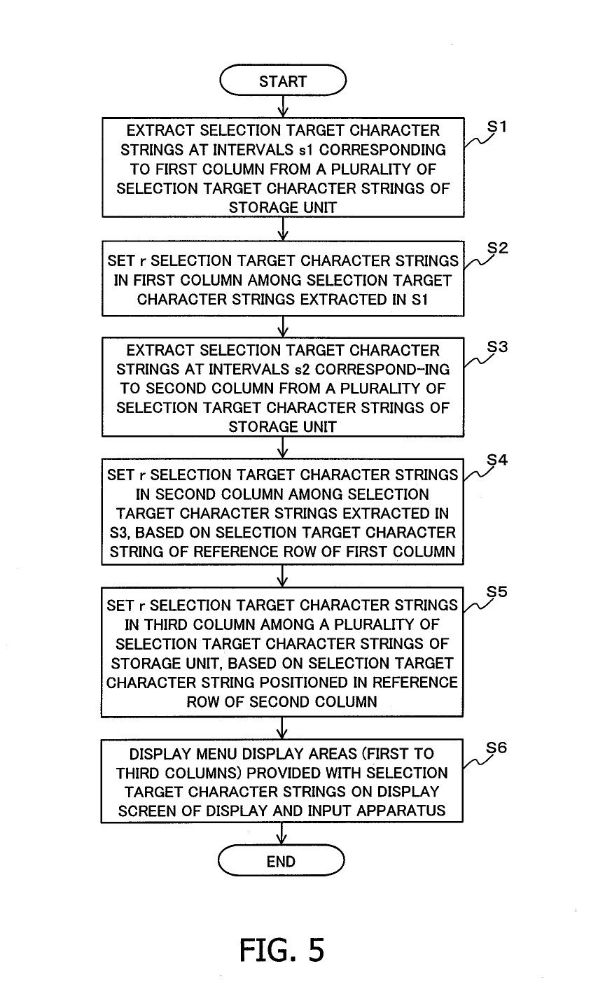

FIG. 5 is a diagram illustrating a processing flow example of the menu display unit 12 of the character string selecting apparatus 1 according to the first embodiment. In the processing flow example shown in FIG. 5, the number of menu display areas (n=3) and the number of rows (r=10) provided on the display screen as well as the intervals (s1, s2, and s3) corresponding to the menu display areas are set before the start of processing.

When a start of processing is input in the character string selecting apparatus 1, the menu display unit 12 executes the following process of steps S1 to S6.

Step S1: When the input of a character string selection process is started, the menu display unit 12 extracts selection target character strings with corresponding numbers at the intervals s1 (value: 100) in the first column 31 of the menu display areas, from the plurality of selection target character strings stored in the storage unit 2.

Step S2: The menu display unit 12 extracts r number of selection target character strings from the selection target character strings extracted in the process of step S1 and sets the character strings in the first column 31.

Step S3: The menu display unit 12 extracts selection target character strings with corresponding numbers at the intervals s2 (value: 10) in the second column 32 of the menu display areas, from the plurality of selection target character strings of the storage unit 2.

Step S4: The menu display unit 12 sets r number of previous and subsequent selection target character strings in the second column 32 based on the selection target character string corresponding to the selection target character string of the reference row of the first column 31, from among the selection target character strings extracted in the process of step S3.

Step S5: Based on the intervals s3 (value: 1) in the third column 33 of the menu display areas, the menu display unit 12 extracts all selection target character strings from the plurality of selection target character strings of the storage unit 2. The menu display unit 12 sets r number of previous and subsequent selection target character strings in the third column 33 based on the selection target character string corresponding to the selection target character string of the reference row of the second column 32.

Step S6: The menu display unit 12 displays the first to third columns 31 to 33 provided with the extracted selection target character strings on the display screen of the display and input apparatus 3 through the input-output interface 11.

FIG. 6 is a diagram illustrating a display example of the menu display areas displayed on the display screen of the display and input apparatus 3 in the processing flow shown in FIG. 5.

The first to third columns 31 to 33 display the selection target character strings extracted at the intervals different in each column, from the plurality of selection target character strings stored in the storage unit 2.

The first column 31 displays selection target character strings, such as “A-ri-u-mu (101), E-bi-ne (201), Ka-e-no-ri-na-mu (301), Ki-ba-na-ko-su-mo-su (401), and Sa-ru-bi-gu-ro-si-su (501)”, among the selection target character strings extracted at the widest intervals. The numbers in the parentheses following the selection target character strings represent numbers indicating the display order of the character strings.

The second column 32 displays selection target character strings, such as “Ka-a-be-ra (371), Ka-ra-a (381), Ka-ro-ra-i-na-ja-su-mi-n (391), Ki-ba-na-ko-su-mo-su (401), and Ki-n-mo-ku-se-i (411)”, extracted based on the selection target character string (Ki-ba-na-ko-su-mo-su) of the reference row of the first column, from among the selection target character strings extracted at the next widest intervals. The third column 33 displays selection target character strings, such as “Ki-ku (398), Ki-ti-jo-u-so-u (399), Ki-bo-u-si (400), Ki-ba-na-ko-su-mo-su (401), Ka-tu-te-i-ru (402), and Ka-to-mi-n-to (403)”, extracted based on the selection target character string (Ki-ba-na-ko-su-mo-su) of the reference row of the first column, from among the selection target character strings sequentially extracted at the narrowest intervals.

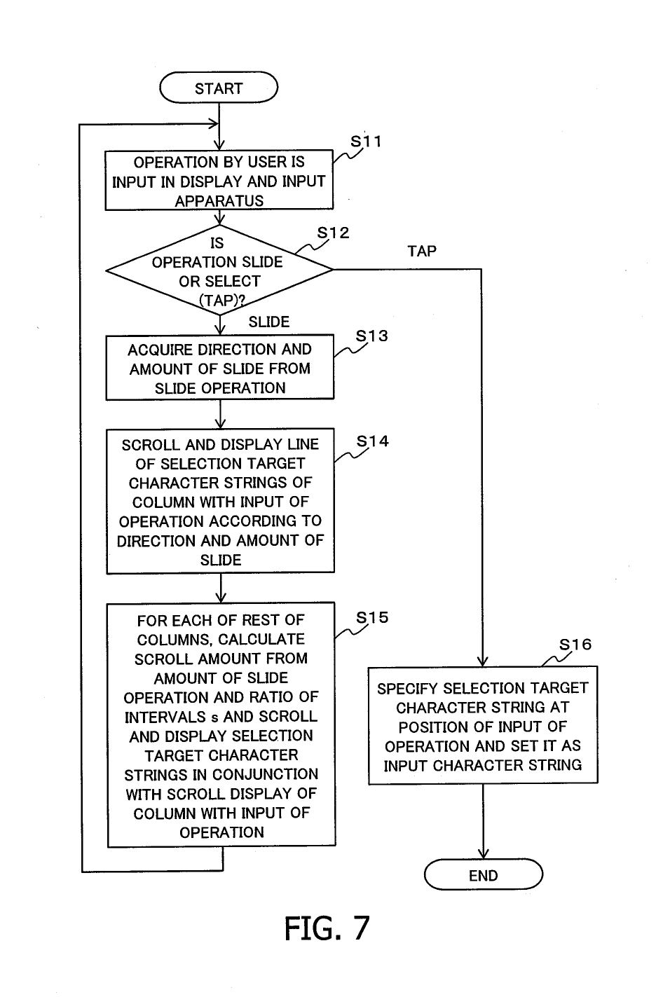

FIG. 7 is a diagram illustrating a processing flow example of the slide operation processing unit 13 and the character string selection unit 14 of the character string selecting apparatus 1 according to the first embodiment.

When the menu display unit 12 displays the first to third columns 31 to 33 of the menu display areas including the selection target character strings on the display screen shown in FIG. 6, the process is started. The slide operation processing unit 13 executes the following process of steps S11 to S15, and the character string selection unit 14 executes the process of step S16.

Step S11: The operation by the user is input on the display screen of the display and input apparatus 3.

Step S12: The input-output interface 11 determines whether the operation is slide or select (tap). The process proceeds to step S13 if the operation is “slide”, and the process proceeds to step S16 if the operation is “tap” selection operation.

Step S13: When it is determined that the operation is “slide” in the process of step S12, the slide operation processing unit 13 acquires the menu display area (column) with the input of the slide operation as well as the direction and the amount of the slide operation. The slide operation processing unit 13 may acquire the speed of the slide operation instead of the amount of slide.

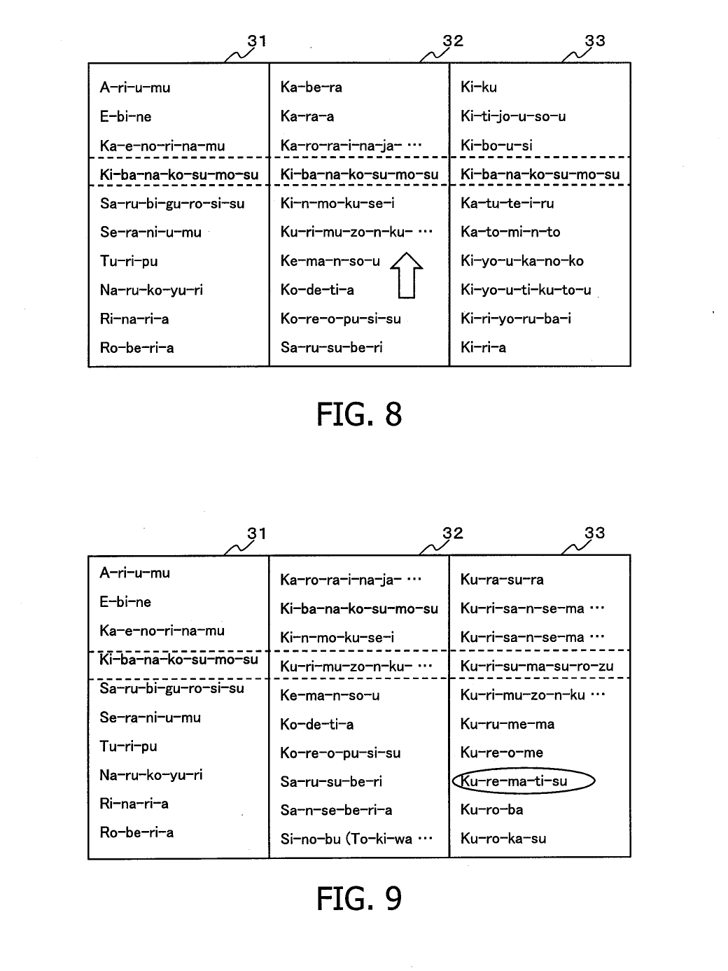

FIG. 8 is a diagram illustrating an example of the menu display areas at the time of the input of the slide operation. In FIG. 8, an arrow of the menu display area (second column) 32 indicates the slide operation, illustrating that slide operation for two rows in the upper direction is input in the menu display area (second column) 32.

Step S14: The slide operation processing unit 13 scrolls and displays the selection target character strings of the second column 32 with the input of the slide operation, according to the slide operation (two rows in the upper direction).

Step S15: The slide operation processing unit 13 scrolls and displays the selection target character strings of the first column 31 and the third column 33 in conjunction with the scroll display of the second column 32. The slide operation processing unit 13 scrolls and displays the selection target character strings of the first column 31 in the upper direction based on the amount of scroll (two rows (10/100=1/5 rows) obtained by “amount of slide (ratio of intervals of the first column and the second column (s2/s1)”. Similarly, the slide operation processing unit 13 scrolls and displays the selection target character strings of the third column 33 based on the amount of scroll (two rows (10/1=20 rows) obtained by “amount of slide (ratio of intervals of second column and third column (s2/s3)”.

FIG. 9 is a diagram illustrating an example of the scroll display of the menu display areas based on the slide operation. The selection target character strings are scrolled in the upper direction in each of the menu display areas (columns) shown in FIG. 9. The first column 31 is scrolled by 1/5 rows, the second column 32 is scrolled by two rows, and the third column 33 is scrolled by 20 rows. In this way, the selection target character strings are scrolled and displayed based on different amounts of scroll.

Step S16: When it is determined that the operation is “tap” in the process of step S12, the character string selection unit 14 specifies the selection target character string at the position of the input of the selection operation and sets the character string as an input character string. The character string selection unit 14 specifies the selection target character string “Ku-re-ma-ti-su” from the position (indicated by an ellipse) of the input of the selection operation in the third column 33 shown in FIG. 9 and sets the character string as an input character string.

When the last selection target character string of the plurality of selection target character strings stored in the storage unit 2 is displayed in a row in the middle of any of the columns of the menu display areas 31 to 33, the rows following the last selection target character strings may be blank rows, or the selected selection target character strings may be set and displayed from the top of the extracted selection target character strings.

As described, the character string selecting apparatus 1 can simultaneously display, in a plurality of menu display areas (columns), the lines of the selection target character strings extracted at a plurality of different intervals from a large number of selection target character strings and can scroll and display the menu display areas (columns) in conjunction with each other according to one slide operation. Therefore, the user can quickly reach near the display order of the desired selection target character string to select the character string.

Another embodiment (second embodiment) of the character string selecting apparatus 1 will now be described.

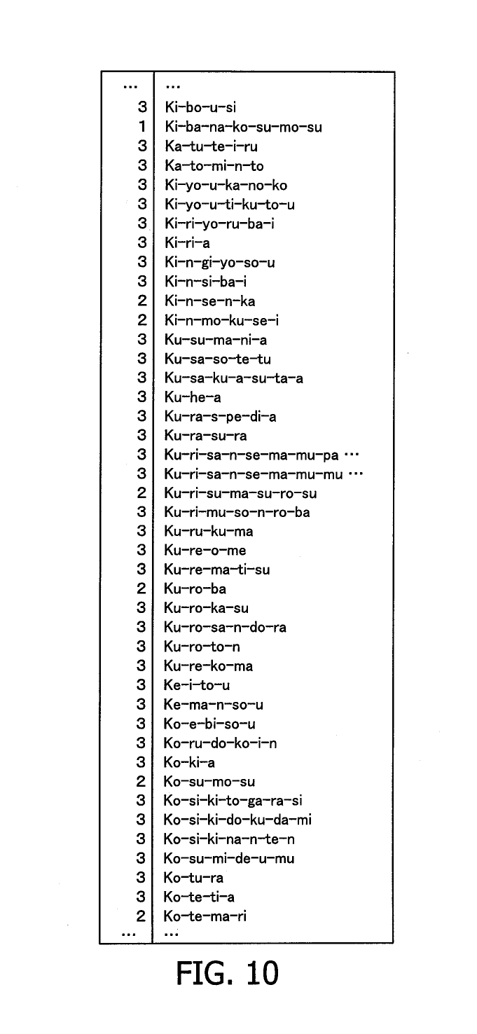

FIG. 10 is a diagram illustrating an example of a plurality of selection target character strings stored in the storage unit 2 according to the second embodiment. A configuration example of the character string selecting apparatus 1 according to the second embodiment is almost the same as the configuration example of the character string selecting apparatus 1 according to the first embodiment shown in FIG. 1.

The storage unit 2 according to the second embodiment stores a plurality of selection target character strings in which the order relation of the display order is set, and each of the plurality of selection target character strings is provided with a degree of importance. In FIG. 10, numbers on the left of the selection target character strings indicate the degrees of importance provided to the selection target character strings. The degree of importance is, for example, classification of the frequency of selection of the selection target character string or classification of various evaluations for the selection target character string, and the number of selection target character strings with a higher degree of importance provided to each level of the degree of importance is set at a certain ratio. With reference to the example described above, a degree of importance 1 is 1/100 of the total number, and a degree of importance 2 is 1/10 of the total number. In this way, the number of selection target character strings provided with the degree of importance of the level just above is smaller than that of the level just below. In the example shown in FIG. 10, the degree of importance includes classes (1 to 3) corresponding to the number of menu display areas. The degree of importance is higher in the order of 1, 2, and 3, and the number of provided selection target character strings is smaller.

The menu display unit 12 of the character string selecting apparatus 1 according to the second embodiment uses the degrees of importance provided to the plurality of selection target character strings corresponding to each menu display area (column) to extract the selection target character strings.

When a slide operation is input, the slide operation processing unit 13 uses the amount of slide and the ratio of the numbers of selection target character strings from corresponding one selection target character string to the next selection target character string in the column in which the slide operation is input and in the column in which the slide operation is not input in order to calculate the amount of scroll for each of the columns other than the menu display area (column) with the input of the slide operation. Then the slide operation processing unit 13 scrolls and displays the selection target character strings based on the amount of scroll obtained in the calculation.

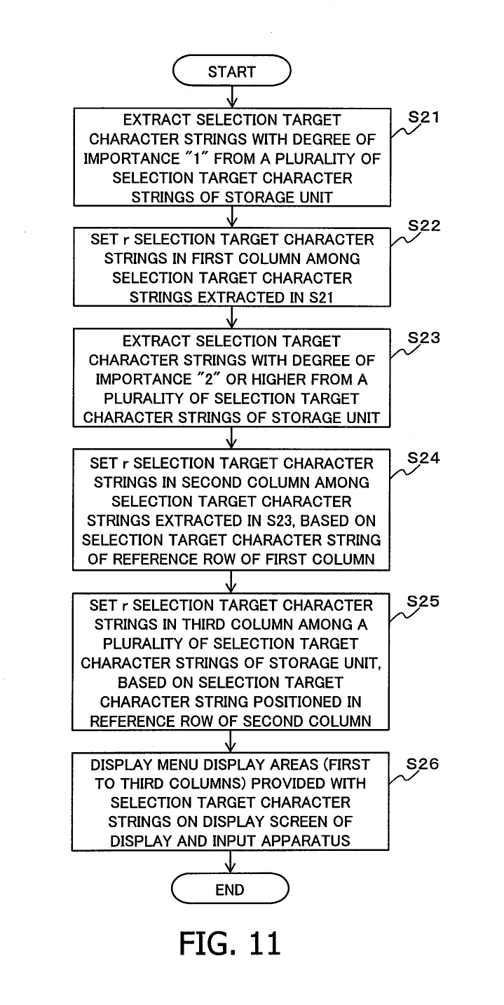

FIG. 11 is a diagram illustrating a processing flow example of the menu display unit 12 of the character string selecting apparatus 1 according to the second embodiment. In the second embodiment, the number of menu display areas (n=3) provided on the display screen is the same as in the first embodiment.

Step S21: When the start of processing is input, the menu display unit 12 extracts the selection target character strings with the degree of importance “1” from the plurality of selection target character strings stored in the storage unit 2.

Step S22: The menu display unit 12 sets r number of selection target character strings in the first column 31 from among the selection target character strings extracted in the process of step S21.

Step S23: The menu display unit 12 extracts the selection target character strings with the degree of importance “2” or higher (degree of importance is “1” or “2”) from the plurality of selection target character strings of the storage unit 2.

Step S24: Among the selection target character strings extracted in the process of step S23, the menu display unit 12 sets r number of previous and subsequent extracted selection target character strings in the second column 32 based on the selection target character string corresponding to the selection target character string in the reference row of the first column 31.

Step S25: The menu display unit 12 extracts the selection target character strings with the degree of importance “3” or higher (degree of importance is “1”, “2”, or “3”), i.e. all selection target character strings, from the plurality of selection target character strings of the storage unit 2. Therefore, the menu display unit 12 sets r number of previous and subsequent extracted selection target character strings in the third column 33 based on the selection target character string corresponding to the selection target character string in the reference row of the second column 32.

Step S26: The menu display unit 12 displays the first to third columns 31 to 33 provided with the selection target character strings on the display screen of the display and input apparatus 3 through the input-output interface 11.

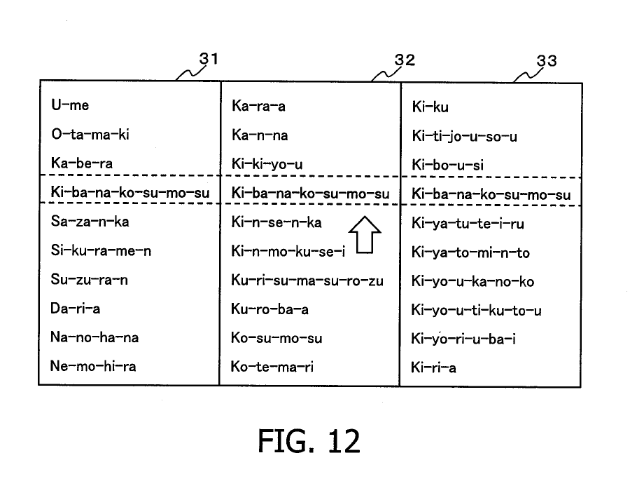

FIG. 12 is a diagram illustrating a display example of the menu display areas displayed on the display screen of the display and input apparatus 3 in the processing flow shown in FIG. 11. The selection target character strings extracted from the plurality of selection target character strings shown in FIG. 3 based on the degrees of importance are displayed in the first to third columns 31 to 33 of the menu display areas shown in FIG. 12.

For example, the selection character strings, such as “U-me, O-ta-ma-ki, Ka-a-be-ra, Ki-ba-na-ko-su-mo-su, and Sa-za-n-ka”, set in the process of step S22 are displayed in the first column 31. The selection character strings, such as “Ka-ra-a, Ka-n-na, Ki-ki-yo-u, Ki-ba-na-ko-su-mo-su, and Ki-n-mo-ku-se-i”, set in the process of step S24 are displayed in the second column 32. The selection character strings, such as “Ki-ku, Ki-ti-jo-u-so-u, Ki-bo-u-si, Ki-ba-na-ko-su-mo-su, Ki-ya-tu-te-i-ru, and Ki-ya-to-mi-n-to”, set in the process of step S25 are displayed in the third column 33.

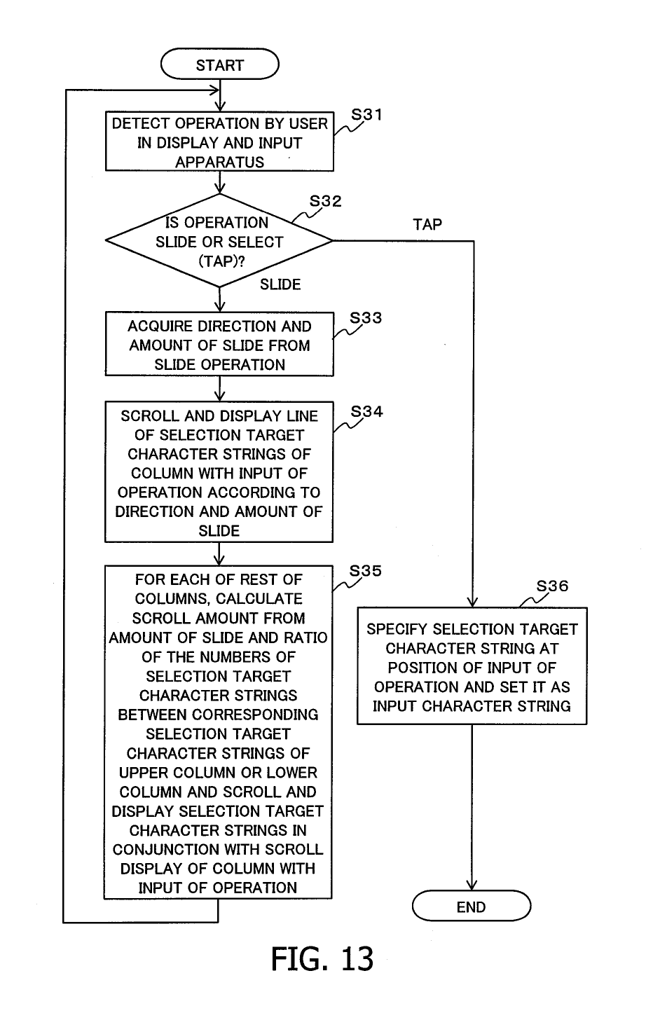

FIG. 13 is a diagram illustrating a processing flow example of the slide operation processing unit 13 and the character string selection unit 14 of the character string selecting apparatus 1 according to the second embodiment.

When the menu display unit 12 displays the menu display areas shown in FIG. 12 on the display screen of the display and input apparatus 3, the process is started. The slide operation processing unit 13 executes the following process of steps S31 to S35, and the character string selection unit 14 executes the process of step S36. Here, the processes of steps S31 to S34 and S36 are the same as the processes of steps S11 to S14 and S16 of the processing flow of FIG. 7 described in the first embodiment, and the description will not be repeated.

In the process of step S35, the slide operation processing unit 13 scrolls and displays the lines of the selection target character strings in the first column 31 and the third column 33 in conjunction with scrolling of the display of the second column 32 with the input of the slide operation. Specifically, the slide operation processing unit 13 uses the amount of slide and the ratio of the numbers of selection target character strings between corresponding selection target character strings in the third column and the second column in order to calculate the amount of scroll for the third column 33 and scrolls and displays the selection target character strings based on the calculated amount of scroll. An example of the calculation will be illustrated. The interval between the selection target character strings “Ki-ba-na-ko-su-mo-su” and “Ki-n-se-n-ka” is equivalent to one row in the second column 32 with the input of the slide operation, and the interval between “Ki-ba-na-ko-su-mo-su” and “Ki-n-se-n-ka” is equivalent to nine rows in the third column 33 to be processed. Therefore, the selection target character strings are scrolled and displayed in the upper direction based on the amount of scroll (9 rows=1 row (9/1) obtained by the calculation. For the first column 31, the amount of scroll (1/56 rows=1 row (1/56) obtained by similar calculation is significantly small, and the selection target character strings are displayed as it is without scroll display.

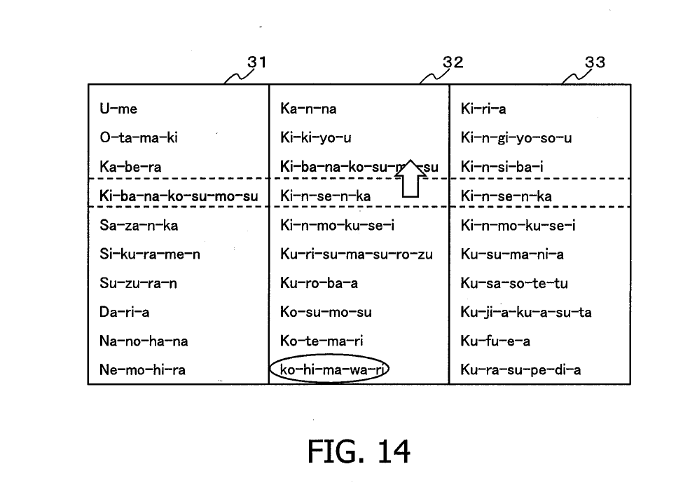

FIG. 14 is a diagram illustrating an example of the scroll display of the menu display areas based on the slide operation. Although the selection target character strings of each column are scrolled in the upper direction in the menu display areas shown in FIG. 14, the character strings are not scrolled in the first column 31. The character strings are scrolled and displayed based on the amount of scroll of one row in the second column 32 and the amount of scroll of nine rows in the third column 33. In the process of step S36, the selection target character string “Ko-hi-ma-wa-ri” is specified from the position (indicated by an ellipse) of the input of the selection operation, and the character string is set as an input character string.

According to the character string selecting apparatus 1 of the second embodiment, the line of the selection target character strings extracted by the same degree of importance from a large number of selection target character strings is displayed in each column. Therefore, the user can slide the selection target character strings with reference to the degrees of importance. The user can more easily reach the desired selection target character string and can more easily select the desired selection target character string.

Another embodiment (third embodiment) of the character string selecting apparatus 1 will now be described. A configuration example of the character string selecting apparatus 1 according to the third embodiment is the same as the configuration example of the character string selecting apparatus 1 according to the first embodiment shown in FIG. 1.

In the third embodiment, the menu display unit 12 of the character string selecting apparatus 1 can display selection target character strings without overlapping when displaying the selection target character strings in a plurality of menu display areas (first to third columns) on the display screen of the display and input apparatus 3.

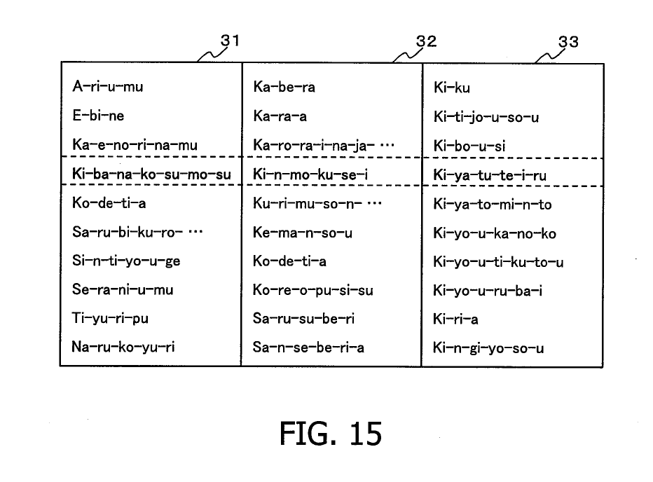

FIG. 15 is a diagram showing an example of the menu display areas displayed on the display screen of the display and input apparatus 3 according to the third embodiment.

The menu display unit 12 removes the selection target character strings displayed in the previous first column from the selection target character strings extracted for the second column 32 and then sets a predetermined number of selection target character strings in the second column 32. In the first embodiment, the same selection target character string “Ki-ba-na-ko-su-mo-su” is displayed in the reference rows of the first to third columns 31 to 33 of the menu display areas as shown in FIG. 6. In the third embodiment, when extracting the selection target character strings displayed in the columns of the menu display areas shown in FIG. 6, the menu display unit 12 removes “Ki-ba-na-ko-su-mo-su” from the selection target character strings of the second column 32 because “Ki-ba-na-ko-su-mo-su” in the selection target character strings extracted for the second column 32 is extracted as a selection target character string of the first column 31. The menu display unit 12 further extracts a selection target character string “Sa-n-se-be-ri-a”. Similarly, the menu display unit 12 removes “Ki-ba-na-ko-su-mo-su” from the selection target character strings of the third column 33 and further extracts a selection target character string “Ki-n-gi-yo-so-u”. In the menu display areas shown in FIG. 15, the menu display unit 12 displays r selection target character strings including the selection target character string “Sa-n-se-be-ri-a” in the second column 32 and displays r selection target character strings including the selection target character string “Ki-n-gi-yo-so-u” in the third column 33.

According to the character string selecting apparatus 1 of the third embodiment, as many selection target character strings as possible can be displayed on the menu display areas.

The third embodiment can be implemented by combining the first and second embodiments.

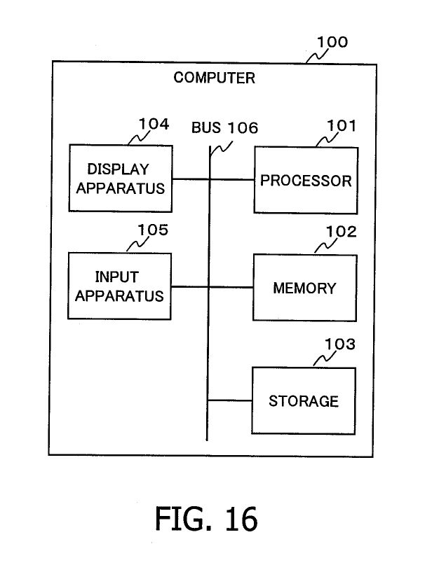

FIG. 16 is a diagram illustrating a hardware configuration example of the character string selecting apparatus 1.

The character string selecting apparatus 1 can be implemented as a computer 100 shown in FIG. 16. The computer 100 includes, for example, a processor (CPU) 101, a memory 102, a storage 103, a display device 104, and an input device 105, and these units and devices are connected to a bus 106.

The processor 101 controls the entire computer 100 and executes programs stored in the storage 103 in cooperation with the memory 102 and the storage 103. The memory 102 is a storage device such as a RAM (Random Access Memory), and programs executed by the processor 101 are loaded. The memory 102 is a main memory storing data used for processing by the processor 101. The memory 102 is a RAM (Random Access Memory) or the like that temporarily stores programs and data stored in an external storage device or a portable data recording medium in a process of program execution, data update or the like. The storage 103 is a storage device, such as an HDD (Hard Disk Drive) and a flash memory, and programs and various data area stored.

The display device 104 is a display unit or the like and outputs a processing result of the computer 100. The input device 105 is a touch panel, a keyboard, a mouse, and the like and receives an operation instruction through user operation or the like.

The storage unit 2 of the character string selecting apparatus 1 described in the embodiments is one of the memory 102 and the storage 103. The display and input apparatus 3 is the display device 104 and the input device 105.

The input-output interface 11, the menu display unit 12, the slide operation processing unit 13, and the character string selection unit 14 included in the processing apparatus 10 of the character string selecting apparatus 1 can also be implemented by programs that can be executed by the computer 100. In this case, programs describing details of processing by the processing unit are provided, and the computer 100 executes the provided programs to realize the functions of the processing unit on the computer 100.

As described, the character string selecting apparatus 1 of the present invention displays, in a plurality of areas, the selection target character strings extracted at different intervals for the menu display areas, from the plurality of selection target character strings stored in the storage unit 2. As a result, the user can simultaneously view the plurality of selection target character strings provided with the order of display, as lines of character strings in a wide range or a narrow range. The user can more easily predict the displayed position of the desired selection target character string.

The character string selecting apparatus 1 of the present invention scrolls and displays the lines of the selection target character strings displayed in the plurality of menu display areas in conjunction with each other, according to one slide operation input in the plurality of menu display areas. As a result, the user can perform one slide operation to check the plurality of selection target character strings in a plurality of ranges with different sizes, and the user can easily recognize the display order of the desired selection target character string.

As described, the present invention can provide user-friendly means for character string selection, which means can reach, by a small number of times of operation, near the position of the display order of the selection target character string desired by the user to select the desired selection target character string from a plurality of selection target character strings.

The present invention is useful for a system that selects, by simple operation, an item from a large number of selection items with a prescribed relation, such as Japanese kana “a, i, u, e, o” order, alphabetical order, or the like. Particularly, the present invention is suitable for selecting a singer name or a song name using a remote control of a karaoke system, for searching a facility name or a place name in a car navigation system, and so forth.

All examples and conditional language recited herein are intended for pedagogical purposes to aid the reader in understanding the invention and the concepts contributed by the inventor to furthering the art, and to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A character string selecting apparatus for a user to select a character string from a plurality of selection target character strings displayed on a display apparatus, the character string selecting apparatus comprising:
a storage unit for storing the plurality of selection target character strings provided with an order relation of a display order;
a menu display unit for setting n (n is an integer equal to or greater than 2) number of menu display areas on a display screen of the display apparatus, displaying, in a first menu display area, selection target character strings extracted at intervals in the display order from among the plurality of selection target character strings stored in the storage unit, and displaying, in an i-th (2≦i≦n) menu display area, selection target character strings extracted at intervals smaller than intervals of selection target character strings displayed in an i-1-th menu display area;
a slide operation processing unit for receiving input of slide operation in the n number of menu display areas, scrolling and displaying selection target character strings in a j-th (1≦j≦n) menu display area in response to the input of the slide operation in the j-th menu display area, and scrolling and displaying the selection target character strings in the other menu display areas in conjunction with each other based on amounts of scroll according to the intervals; and
a character string selection unit for receiving input of selection operation of a selection target character string in the n menu display areas to specify the selected selection target character string.

2. The character string selecting apparatus according to claim 1, wherein the intervals are certain intervals that are set for each of the menu display areas or intervals that are set based on additional information provided in advance to each of the selection target character strings.

3. A character string selecting method for a user to select a character string from a plurality of selection target character strings displayed on a display apparatus, the character string selecting method comprising:
setting n (n is an integer equal to or greater than 2) number of menu display areas on a display screen of the display apparatus;
displaying, in a first menu display area, selection target character strings extracted at intervals in a display order from among the plurality of selection target character strings provided with an order relation of the display order and displaying, in an i-th (2≦i≦n) menu display area, selection target character strings extracted at intervals smaller than intervals of selection target character strings displayed in an i-1-th menu display area;
receiving input of slide operation in the n number of menu display areas;
scrolling and displaying selection target character strings in a j-th (1≦j≦n) menu display area in response to the input of the slide operation in the j-th menu display area, and scrolling and displaying the selection target character strings in the other menu display areas in conjunction with each other based on amounts of scroll according to the intervals; and
receiving input of selection operation of a selection target character string in the n number of menu display areas to specify the selected selection target character string.

4. The character string selecting method according to claim 3, wherein the intervals are certain intervals that are set for each of the menu display areas or intervals that are set based on additional information provided in advance to each of the selection target character strings.

5. A computer-readable medium storing a character string selecting program for causing a computer to execute a process for a user to select a character string from a plurality of selection target character strings displayed on a display apparatus, the process comprising:
setting n (n is an integer equal to or greater than 2) number of menu display areas on a display screen of the display apparatus;
displaying, in a first menu display area, selection target character strings extracted at intervals in a display order from among the plurality of selection target character strings provided with an order relation of the display order and displaying, in an i-th (2≦j≦n) menu display area, selection target character strings extracted at intervals smaller than intervals of selection target character strings displayed in an i-1-th menu display area;
receiving input of slide operation in the n menu display areas;
scrolling and displaying selection target character strings in a j-th (1≦j≦n) menu display area in response to the input of the slide operation in the j-th menu display area, and scrolling and displaying the selection target character strings in the other menu display areas in conjunction with each other based on amounts of scroll according to the intervals; and
receiving input of selection operation of a selection target character string in the n menu display areas to specify the selected selection target character string.

6. The computer-readable medium storing a character string selecting program according to claim 5, wherein the intervals are certain intervals that are set for each of the menu display areas or intervals that are set based on additional information provided in advance to each of the selection target character strings.
